(19) United States
(12) Patent Application Publication
(10) Pub. No.: US 2004/0186783 A1
(43) Pub. Date: Sep. 23, 2004

(54) Time sensitive inventory sales system

(76) Inventors: Paul Knight, Fort Collins, CO (US); Larry Salmen, Fort Collins, CO (US); Russell S. Krajec, Berthoud, CO (US)

Correspondence Address: The Law Offices of William W. Cochran, LLC, 3555 Stanford Road, Suite 230, Fort Collins, CO, 80525, US

(21) Appl. No.: 10/769,098

(22) Filed: Jan. 30, 2004

Related U.S. Application Data
(63) Continuation-in-part of application No. 10/175,226, filed on Jun. 17, 2002, now abandoned.
(60) Provisional application No. 60/374,892, filed on Apr. 22, 2002.

(51) Int. Cl. G06F 17/60

(52) U.S. Cl. 705/16; 705/14; 705/27

(57) ABSTRACT

Inventory data, including time sensitive inventory data, are used to rank a list of choices presented at a point of sale terminal. Based on the ranked list of choices, the system and method may present one or more of the choices to the consumer through a ranked list, highlighting, promoting, or otherwise accentuating one or more choices. The system and method use a real time inventory system to evaluate the economic benefit for promoting a particular item contained in the ranked list.

### CROSS REFERENCE TO RELATED APPLICATIONS

This application is a continuation-in-part of U.S. patent application Ser. No. 10/175,226 entitled “Point of Sale Selection System” by Russell S. Krajec filed Jun. 17, 2002, the entire content of which is hereby incorporated by reference herein for all it discloses and teaches.

This application claims the benefit of U.S. Provisional Patent Application 60/374,892 entitled “Point of Sale Selection System” by Russell S. Krajec filed Apr. 22, 2002, the entire content of which is hereby incorporated by reference herein for all it discloses and teaches.

### BACKGROUND OF THE INVENTION

a. Field of the Invention

The present invention pertains generally to consumer recommendation systems used to aid purchases and specifically to recommendation systems that use a point of sale interface with a link to the store inventory.

b. Description of the Background

Many sales are assisted or automated with kiosks, point of sale terminals, and other computerized interfaces. In some cases, the consumer interacts directly with the computerized interface, such as a self service kiosk or web interface, or with a clerk who enters the items into a point of sale terminal, such as with a call center, a walk up lobby, drive through window, or the like. These interfaces help in processing a transaction quickly and efficiently.

Video rental stores often have a wide variety of movies spanning many genres. For the casual movie fan, selecting a movie may be a daunting task, given the wide variety of movies. Many selections are made based on reading the jackets of the movies arrayed on a shelf, which the renter must browse to find a movie to enjoy. For those people wishing to see a movie similar to one they had already viewed, a recommendation from a friend or store clerk may have to suffice.

In some cases, the renter may wish to view a movie trailer prior to renting it. A description of the movie plot, actor's and director's names, plus other criteria may be helpful in locating and selecting a movie.

Similarly, customers in bookstores and music stores have need to search and preview a selection of books or music titles to assist in finding the right book or music CD or other media.

The customer may wish to have some information relating to the immediate availability of the various recommendations. For a computer recommendation system to suggest titles that are not available would be disheartening to the customer.

The retailer has various titles that may not rent very often. The slower moving titles represent inventory for which little revenue is generated. Customers expect that a large video store have a correspondingly large inventory, however, most of the store revenue is generated by the newest releases. The film makers advertise and promote movies as they are released, but not after they have been sitting on the shelves of the video store for an extended period of time. The older movies are relegated to a discount section of the store and the retailer has few options to promote these titles.

Retail food sales establishments, including ready to eat restaurants, supermarkets, delis, and other sales outlets sell items that have a shelf life. If the inventory item spoils, the item is discarded at a loss to the establishment.

It would therefore be advantageous to provide a device and method for browsing and selecting an item that uses the inventory status of the item to direct the consumer towards an item that is advantageous for the business to sell immediately. It would further be advantageous to provide a system and method whereby the real time status of the inventory were used to identify and promote slow moving items or items currently in inventory that have a limited shelf life so that the inventory carrying costs are minimized and profit maximized.

### SUMMARY OF THE INVENTION

The present invention includes a system and method for modifying a list of consumer choices by using inventory data, including time sensitive inventory data, to rank the list of choices. Based on the ranked list of choices, the system and method presents one or more of the choices to the consumer through a ranked list, highlighting, promoting, or otherwise accentuating one or more choices.

Within this specification, reference is made to an exemplary system designed for a video rental store and to a fast food restaurant. Those skilled in the art will appreciate that the present invention may be applied to other retail venues, such as bookstores, music stores, computer game stores, or other stores where various media are sold at retail. Additionally, retail venues such as restaurants, supermarkets, pharmacies, flower shops, hardware stores, and other retail outlets may have applicable embodiments. The embodiments discussed were chosen to represent the inventive concepts but the claimed invention should not be considered as limited to the specific embodiments discussed.

An embodiment of the present invention may therefore include a method of assisting a customer at a point of sale location comprising: determining a first group of items for a sales transaction by using a first computer system; providing a graphical interface on a computerized point of sale terminal; determining an expiration time of at least one item of the first group of items using the first computer system, the determining an expiration time comprising communicating with an inventory tracking system; determining that the at least one item is suitable for promotion based at least in part on the expiration time; creating a graphical representation of the first list of potential choices comprising enhancing the at least one item; and displaying the graphical representation of the first list of potential choices on the graphical interface.

Another embodiment of the present invention may include a system for assisting a customer at a point of sale terminal comprising: a first computer system adapted to determine items for a sales transaction; an inventory tracking system adapted of tracking at least one item of the items and providing an expiration time for the at least one item; the first computer system further adapted to communicate with the inventory tracking system to determine an expiration time of at least one item of the items, determine that the at least one item is suitable for promotion based at least in part on the expiration time, and create a graphical representation of the items comprising enhancing the at least one item; and a graphical interface on the point of sale terminal adapted to receive the graphical representation of the items and display the graphical representation.

Yet another embodiment of the present invention may include a system for assisting a customer at a point of sale location comprising: a first means adapted to determine items for a sales transaction; a second means for providing an expiration time for at least one item of the items; the first means adapted to communicate with the second means and determine that the at least one item is suitable for promotion based at least in part on the expiration time, and create a graphical representation of the items comprising enhancing the at least one item; and a third means for receiving and displaying the graphical representation of the items.

The advantages of the present invention include the maximization of a store's profits by suggesting and promoting the presently available inventory to the consumer in a manner beneficial to the store. At each sale, the inventory of the store may be queried to promote the products that are the most beneficial to the store, such as promoting items that are about to be discarded for being near their ideal shelf life. In another embodiment, items in inventory that are slow movers may be promoted so that the entire available inventory is utilized.

### BRIEF DESCRIPTION OF THE DRAWINGS

In the drawings,

FIG. 1 is an illustration of an embodiment of the present invention of a video store kiosk.

FIG. 2 is an illustration of an embodiment of the present invention of the internal components of a kiosk.

FIG. 3 is an illustration of an embodiment of the present invention showing the network connections of several kiosks to a server that is optionally connected to the internet.

FIG. 4 is an illustration of an embodiment of the present invention showing the network connections between two stores.

FIG. 5 is an illustration of a work flow diagram of an embodiment of the present invention wherein recommendation data are analyzed offline.

FIG. 6 is an illustration of a work flow diagram of an embodiment of the present invention wherein data are processed offline but queries are made on line.

FIG. 7 is an illustration of a work flow diagram of an embodiment of the present invention wherein data are collected and used within a single store.

FIG. 8 is an illustration of a work flow diagram of an embodiment of the present invention wherein a query is processed against several databases.

FIG. 9 is an illustration of a flow diagram of an embodiment of the present invention wherein an item is promoted based on inventory status.

FIG. 10 is an illustration of a clerk order entry screen embodiment of the present invention.

FIG. 11 is an illustration of a customer point of sale kiosk screen embodiment of the present invention.

### DETAILED DESCRIPTION OF THE INVENTION

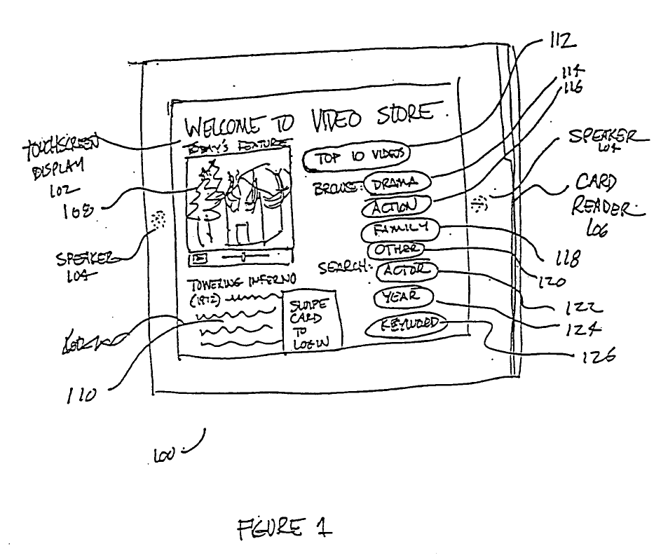

FIG. 1 illustrates an embodiment 100 of the present invention of a video store kiosk. The kiosk 100 comprises a touchscreen display 102, a pair of speakers 104, and a card reader 106. The display includes an area for previewing a movie that includes a motion picture 108 of a scene or preview of the movie, plus a description 110 of the movie. On the right hand side of the screen is a button 112 for a ‘top 10’ list of videos based on popularity. Other buttons 114, 116, 118, and 120 allow the user to browse various genres of movies. Search buttons 122, 124, and 126 allow the user to search for movies based on certain criteria.

The speakers 104 may play an audio track that corresponds with the video being shown in the area 108. When the kiosk 100 has not been used for a period of time, the motion picture 108 and the corresponding audio may be showing a movie that is being simultaneously shown on other television displays or kiosks throughout the store.

The kiosk 100 may be located with other kiosks at a central location in the store or be distributed at various locations in the store. When the kiosk 100 is located at various locations, for example in a section of the store dedicated to action movies, the previews and searches may be directed toward action movies. In other embodiments, the kiosks may be dispersed at various locations in the store but be identical.

The card reader 106 may be used by a user to swipe their identification card to access information particular to their account, such as referencing movies that the user had rented in the past, or indicating any affinity status or special offers that the particular user is eligible to receive. When a search is displayed and the user has swiped their card or otherwise identified themselves to the system, the search results may have the user's previously rented movies highlighted or indicated such that the user will be reminded that they have seen the movies before and may wish to enjoy the movie again. The user may be identified as an affinity user, for example having been a high frequency customer, and may be eligible for special offers or promotions. The special offers or promotions may be available only through the use of the kiosk and may be redeemed automatically at the time of checkout.

An example of a special offer may be to provide a special discount for a specific movie. The discount may only be made available to the identified user when that user has searched for the movie using the kiosk. If the special discount is a discounted price, the price may be saved in the store's local database and retrieved when the customer checks out of the store.

The kiosk may be capable of allowing a user to search for a movie using several methods, such as by actor, director, keywords, or other factor. The results of a search may be a list of movies that fit the search criteria. From the list presented to the user, the user may be able to preview one or several movies. The user may be able to view a written description or summary of the movie, preview a motion picture trailer, view still pictures of the movie, view a review of the movie by a critic, or view any other descriptive data of the movie. The kiosk may be able to display general statistical data of the movie, including the gross receipts, number of academy awards, etc. The kiosk may display statistical data of the rental movie, including its popularity at the particular store or nationally. In some embodiments, a database of comparable movies may be queried to add a list of comparable movies to the search results. For example, a database of comparable movies may relate the movie Terminator to the movie Road Warrior, since the themes and genres are similar. A search for Terminator may result in the movie Road Warrior being displayed as a comparable movie suggestion.

The kiosk may reference a database of popular movies. The popular movie database may be based on historical data of the sales of a particular movie or of comparable movies to a particular movie. The database of popular movies may be kept in a local database within a store location, or may exist on a remote server and shared by many kiosks in many stores.

The kiosk may reference a database of inventory of the store. When a list of movies is presented to the user, those that are already checked out may be highlighted or indicated, and the user may reserve the movie for a specific night. The kiosk may also display certain movies that have not been rented in a while but may be still be within the search criteria.

The central server may operate by processing data and sending updates to the local servers in each store on a periodic basis. In other embodiments, the central server may update the database in real time and also provide query results to each kiosk over the internet in real time.

The kiosk may have several different optional input devices, including a keyboard, microphone, stylus, and any type of personal identification device. A keyboard may be used for textual input or for selecting individual options. A microphone may be used for voice recognition applications, for indicating selections by voice or clapping, or other audible uses. A stylus or pointing device, such as a mouse or trackball, may also be used in lieu of or in addition to a touchscreen interface. Personal identification devices, other than the card reader 106, may be employed. Such devices may include fingerprint readers, retinal scanners, etc.

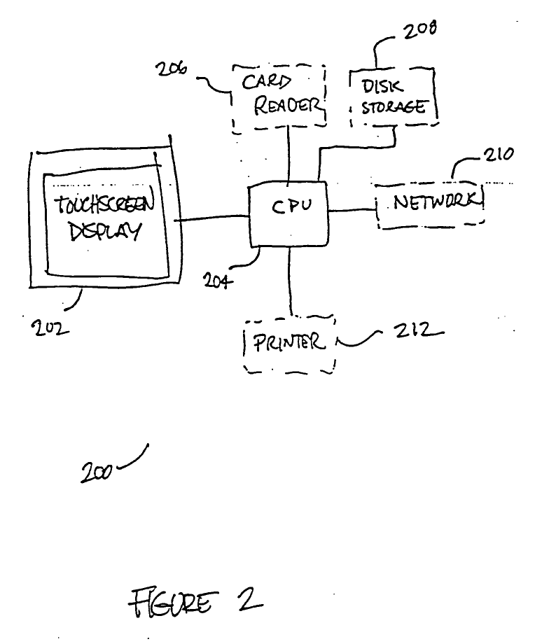

FIG. 2 illustrates an embodiment 200 of the present invention of the internal components of a kiosk. The touchscreen display 202 is connected to a central processing unit (CPU) 204. The CPU 204 may be connected to an optional card reader 206, an optional disk storage 208, an optional network 210, and an optional printer 212. Other accessories and peripherals may be attached to the kiosk 200 by those skilled in the arts without violating the spirit and intent of the present invention.

The embodiment 200 may be configured in a standalone configuration. In such a case, the kiosk 200 may not necessarily have a network connection 210. The standalone configuration may have a disk storage system 208 that can be updated by a CD-ROM or other replaceable media from time to time. Such a configuration may not connect to a central database to retrieve customer specific data and may be used solely for browsing and previewing videos.

The embodiment 200 may be configured to be connected to the internet via the network connection 210. In such a configuration, the embodiment 200 may operate a browser, such as an HTML browser, that communicates over the internet to a central server that receives HTML queries and sends HTML pages for display on the embodiment 200.

The embodiment 200 may be configured as a point of sale system that is used by a store employee, such as a clerk or cashier in a lobby of a restaurant or store or an order taker for a drive through store. Similarly, the embodiment 200 may be used by a pharmacist, herbalist, physician, nutritionist, or other professional to place orders for professionally recommended or prescribed items.

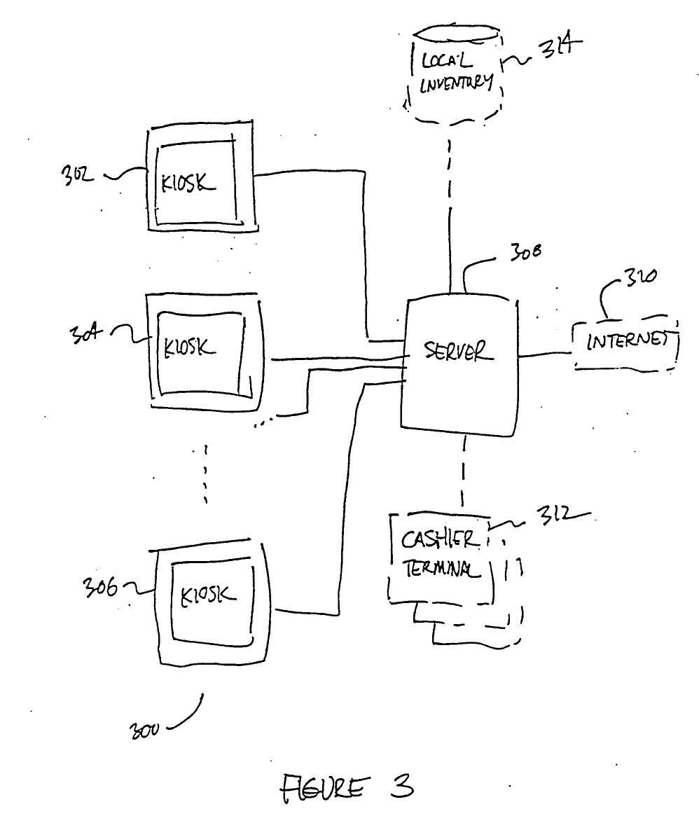

FIG. 3 illustrates an embodiment 300 of the present invention showing the network connections of several kiosks 302, 304, and 306 to a server 308 that is optionally connected to the internet 310. The embodiment 300 illustrates a typical installation inside a single store. Cashier terminals 312 may optionally be connected to the server 308, as well as a local inventory database 314.

The kiosks 302, 304, and 306 may be configured in a client/server configuration with the server 308. The client side may be a thin client or thick client, and those skilled in the art may configure the hardware architecture in several different ways while still keep within the spirit and intent of the present invention. The client may be running an HTML browser and the server may be receiving HTML queries and sending HTML pages for display by the client.

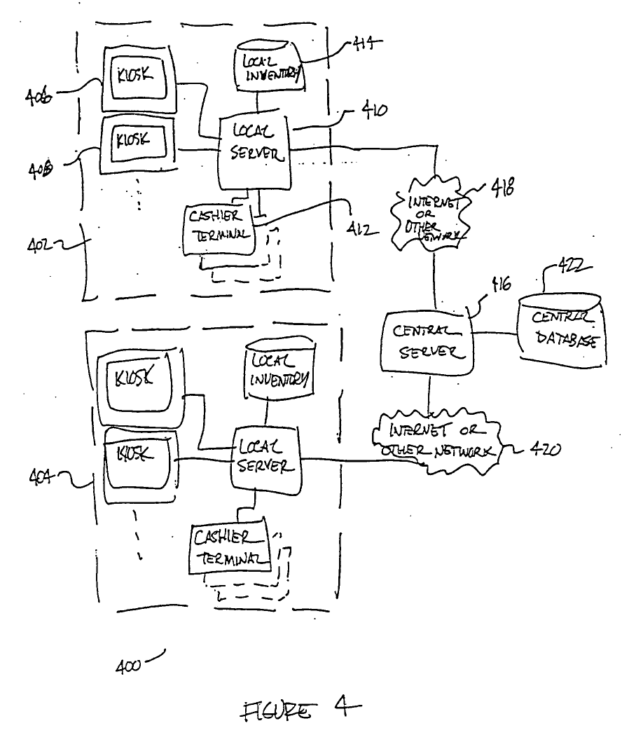

FIG. 4 illustrates an embodiment 400 of the present invention showing the network connections between two stores 402 and 404. Stores 402 contains kiosks 406 and 408, a local server 410, several cashier terminals 412, and a local inventory database 414. Store 404 is configured similarly to store 402. Store 402 is connected to a central server 416 through the internet or other network 418. Store 404 is similarly connected to the central server 416 through the internet or other network 420. The central server 416 is connected to a central database 422.

The stores 402 and 404 may be commonly owned stores or may be independent. In the case of commonly owned stores, the central server 416 may perform accounting and other functions in addition to the video preview and suggestion functions of the present invention. In the case of independent stores, the central server 416 may collect data from the independent stores 402 and 404 and send data back to stores 402 and 404 from time to time. The internet connections 418 and 420 may be connections for passing real time data or may be used intermittently.

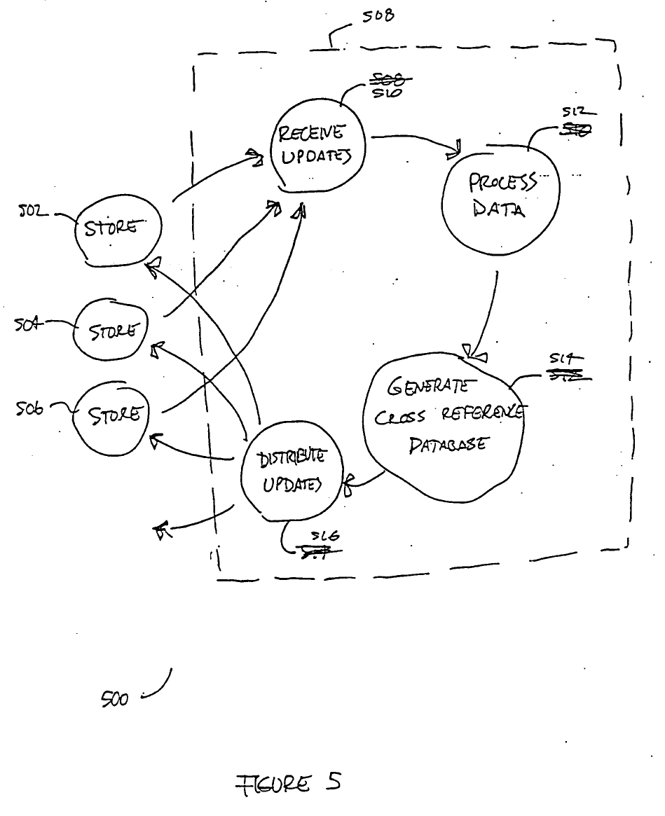

FIG. 5 illustrates a work flow diagram of an embodiment 500 of the present invention wherein recommendation data are analyzed offline. The stores 502, 504, and 506 generate data that can be used for building recommendation data. The offline processing, illustrated by box 508, may be performed by a remote server, such as the central server 416 illustrated in FIG. 4.

The offline processing 508 comprises receiving the data updates 510, processing the data 512, generating a cross reference database 514, and distributing the updates 516. The offline processing of the present embodiment 500 may be performed on a daily or weekly basis, for example. In some embodiments, the processing may be performed on certain days of the week and not on others.

The present embodiment 500 generates a cross reference database 514 that is used to generate a recommendation for a user of a kiosk. The various embodiments of the cross reference database 514 will be described herein after.

The embodiment 500 may be a system used by a retailer with several stores to collect and distribute recommendation data within the retailer's network of stores. In another use, the stores 502, 504, and 506 may be independent stores who subscribe to a service that collects, processes, and distributes the data. Such a service may allow the independent video rental store to provide a recommendation and selection service of a large chain while still maintaining the independence of a small business.

The embodiment 500 has the advantage of generating a large amount of data by consolidating the results from several stores. The present embodiment 500 allows stores with lower sales volume, and thus a smaller amount of sales data, to have an effective recommendation system.

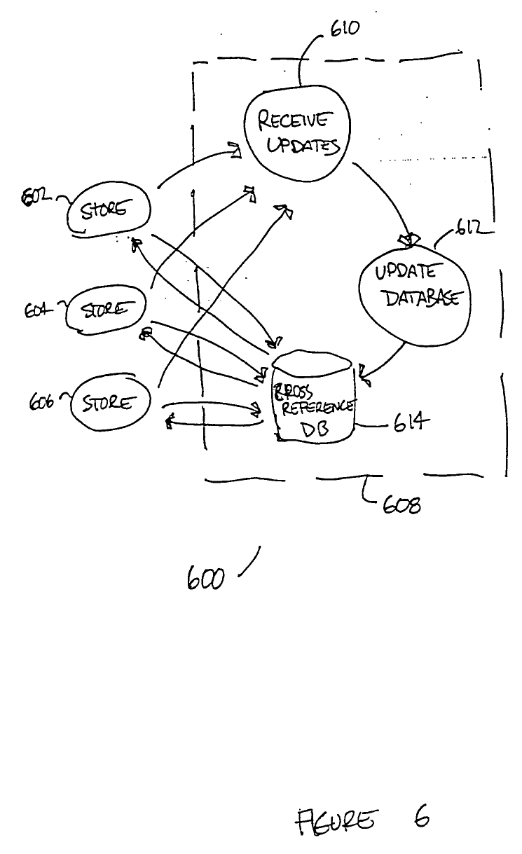

FIG. 6 illustrates a work flow diagram of an embodiment 600 of the present invention wherein data are processed offline but queries are made on line. The stores 602, 604, and 606 are connected to a central server 608, which may be the central server 416 of FIG. 4. Updates are received 610 and the database is updated 612. The cross reference database 614 is directly queried by the stores 602, 604, and 606 for each query. The reference database 614 may be hosted by a web server and the kiosks located in the various stores 602, 604, and 606 may be using a web browser or a modified web browser to query and display results from the reference database 614. In some embodiments, the user may browse a movie's website through the internet.

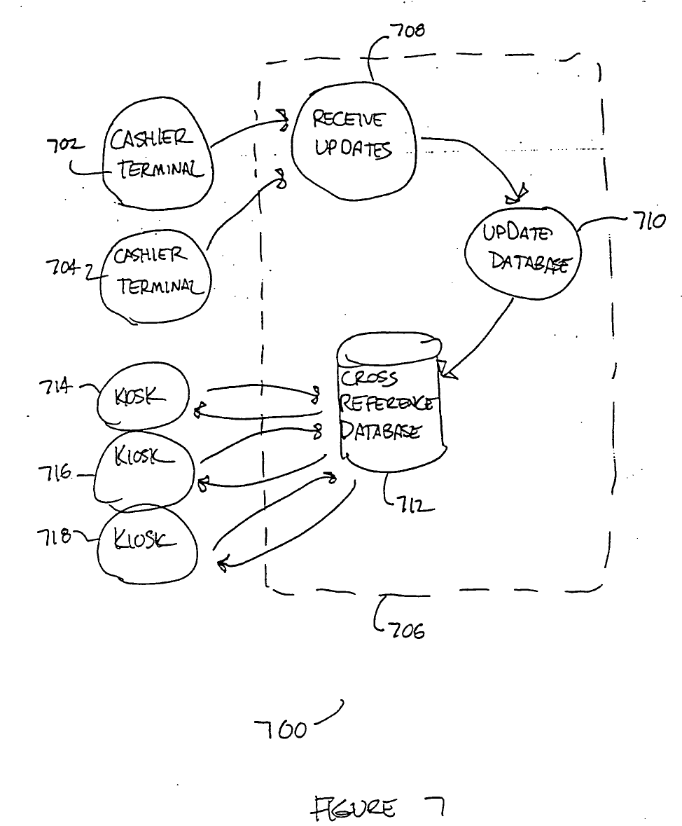

FIG. 7 illustrates a work flow diagram of an embodiment 700 of the present invention wherein data are collected and used within a single store. The cashier terminals 702 and 704 communicate with the local server 706. The local server 706 is similar to the server 308 of FIG. 3. Within the server 706, the data are received 708, the database is updated 710 into the cross reference database 712. The kiosks 714, 716, and 718 query the database 712 and display the results of the queries.

The embodiment 700 represents a system that may be located within a single store. The cross reference database 712 may be updated periodically in a batch mode, such as every night, or the database 712 may be updated with each transaction of the cashier terminal 702 and 704.

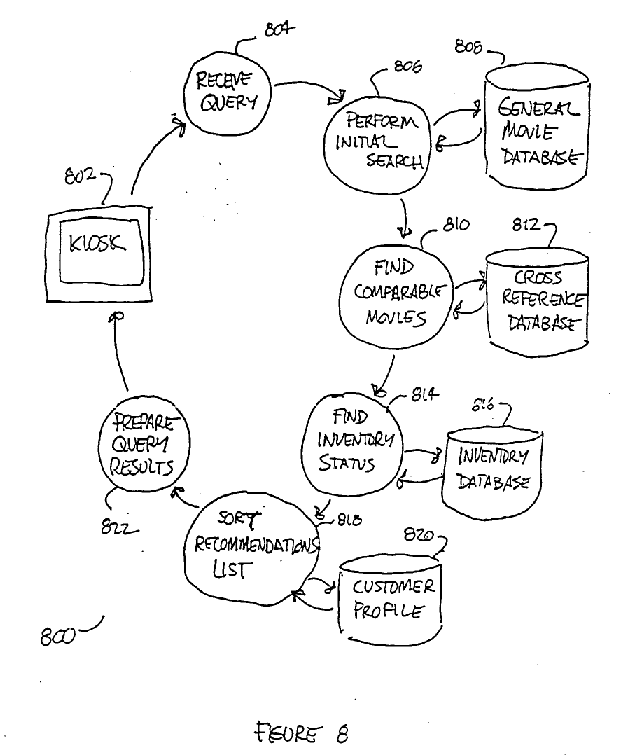

FIG. 8 illustrates a work flow diagram of an embodiment 800 of the present invention wherein a recommendation list is processed. A consumer uses a kiosk 802 to generate a query that is received 804. An initial search is performed 806 against a generate database 808. A second search is performed to find comparable movies 810 against a cross reference database 812. An inventory search 814 is performed against the inventory database 816. The recommendations list is sorted 818, using the customer profile 820. The query results are prepared 822 and sent to the kiosk 802 for display.

The initial search 806 is performed against a general movie database 808. For example, the search may be for movies with the actor Sean Connery. The general movie database 808 may contain references to all of Sean Connery's movies. The initial search 806 may return with a list of movies and also include a ranking index. In the example, those movies in which Sean Connery was the leading actor may be ranked higher than a movie where Sean Connery was a supporting actor.

The list of movies generated with the initial search 806 are ran against the cross reference database 812 to find comparable movies 810. The cross reference database 812 may be a predetermined list of movies that related to other movies, such as those with common keywords, classified by similar genre, have related actors or directors, or any other predetermined cross reference. In addition, the cross reference database 812 may comprise consumer purchasing information for similar movies, such as popularity data compiled over a certain group of stores. The comparable movie search 810 may add many more movie titles to the results of the query. The comparable movie search 810 may include a ranking of popularity or an indicia of the closeness or applicability of the cross referenced title to the initial search. A ranking index for each movie may be compiled from the search 810.

The inventory status 814 of the list of movies is generated against the inventory database 816. Each movie in the query results so far may be compared to see if the movie is within the store's inventory and whether or not the movie is currently checked out. A ranking index may be compiled from the inventory status search 814. For example, slow selling movies may be ranked higher than those for which no inventory is available or those movies that have little inventory available. In some instances, some movies may be specially flagged for promotion based on their inventory status. For example, the results of the inventory status 814 may uncover a movie that has not been rented in a certain period of time. The sort routine may flag that particular movie for an instant promotion. Such a promotion may involve a special discount or a premium such as a bag of popcorn. In some embodiments, the particular movie that is less popular may be combined with a more popular movie as a package set.

The recommendations list may be sorted 818 using the customer profile 820 database. The list of all the results of the initial search 806, plus the comparable movies 808 and the inventory status 814 of all the results, are sorted. The customer profile 820 may include a list of the previously viewed movies for the particular customer. In addition, the customer's preferences, either explicitly or implicitly derived, may be further used to rank the list of recommended movies.

The recommendation list may be sorted by multiplying the ranking indicia of the all the search results and sorting based on the resultant ranking index. The list may have movies previously rented by the customer highlighted or otherwise indicated. In some embodiments, the previously rented movies may be excluded from the recommended list.

The retailer may be able to instantly and automatically identify and promote a slow selling item to someone who has shown at least some interest in the item or a related item. The ability to instantly identify and promote slow selling items may be a large revenue generator for the retailer, allowing the retailer to more efficiently use the existing inventory. The movie recommendation list may be further refined to link two or more movies together as a recommended pair or set of movies to purchase together. For example, the list of Sean Connery movies may have a popular movie bundled with an older, related movie that does not get rented very often. In this manner, the retailer may increase the overall sales by offering an extra movie at a reduced price.

The retailer may offer an instant promotion of a slow selling item such as giving an instant 50% discount for the purchase of the slow selling item. Such a decision may be based on the inventory history of the item, but may also include the customer's purchase history.

A special promotion may be made available to the particular customer based on their past history of movie rentals. For example, for a customer who has consistently purchased only one movie at a time, a bundled pair of movies might be presented at a discount. In another example, a customer who is a consistent and regular customer may be offered two premium movies for a special discount price.

The promotional offer may be such that it is available only through the use of the kiosk. Since the customer may be identified by the swiping of their card through the card reader, a promotion or discount may be made available only to that customer at that time and recalled when the customer checks out of the store.

When a query is sorted, those movies that are not in the current store's inventory of titles may be removed from the list. The removed titles may be stored in a separate database with their ranking indicia for further analysis by the retailer. The removed titles may be sorted to indicate titles that may be considered for addition to the store's inventory. Movies that receive multiple ‘hits’ during the recommendation search may be considered for additions to the store inventory.

The present embodiment 800 may be applied to the on line purchasing of products. In such embodiments, the inventory of an item may be a factor in determining the price of a product. For example, if the inventory search reveals that the product is popular, a premium price might be offered. For items that are overstocked, the price may be reduced. Such offers may be only valid for a certain time, putting some pressure or incentive for the consumer to finish the transaction quickly. For example, if the price was reduced on a slow selling item, the reduced price may only be available for the next thirty minutes, after which the price may return to the original price.

The kiosk may be located at various locations throughout a video rental store and provide a computerized assistance in previewing and selecting movies for rental. The kiosk may be located in the store entranceway, at the point of sale amongst the video titles on a shelf, at or near the check out area, or other places within the store. The kiosk may be used by simply performing searches, browsing movie titles, researching various information about the movies, and checking the inventory status of the movies. The kiosk may allow a user to log in and access lists of previously rented movies. The user may log in by entering their name and password, the user may swipe their personal card issued by the rental store, or by any other method of self identification. By logging in, the search results may show movies that are preferential to the user as well as offering special promotions or discounts to that specific user.

The kiosks may be connected to a local server within a store. The local server may contain the movie database that contains the movie previews, statistical data, and all other data used to perform searches and display results. In some embodiments, the queries may be made to an on line server that resides outside of the store, and the on line server may perform a similar function for several kiosks in a multitude of stores. The central sever may be a service performed for several independent movie rental stores or may only be available to the stores within a certain ownership or corporation.

The server that provides the query results may accept data from a store or stores to compile a database of popular movies. The database may be compiled at certain intervals, such as once a day or once a week, or the database may be updated in real time with real time queries.

The queries or searches performed by a consumer at a kiosk may include the searching of an inventory database. The inventory database may be used to rank slower moving items at a higher place in a list of recommendations for a consumer. Based on the query results of the inventory database, special promotions, such as bundled packages or special discounts, may be offered. In addition, the queries of the inventory database wherein a recommended movie or item is not found in the database may be stored as recommendations for the retailer to increase the store inventory with certain titles.

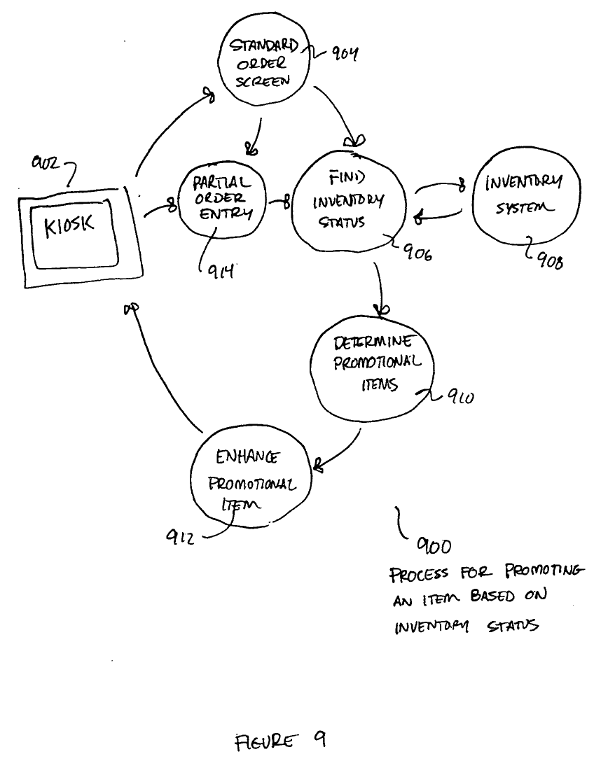

FIG. 9 is a flow diagram illustration of a process 900 for promoting an item based on inventory status. A kiosk 902 has a standard order screen 904. The inventory status 906 of one or more items is checked against an inventory system 908. Based on the inventory status, one or more promotional items are determined 910. The promotional items are enhanced 912 and displayed on the kiosk 902. In some cases, after some processing of an order 914, the process may be repeated.

The kiosk 902 may be any type of point of sale entry system. The kiosk 902 may be used by the consumer as a walk-up kiosk, as a website viewed on the consumer's personal interactive device, such as a computer, personal digital assistant, cellular phone, or other device, or any other device with which the consumer may directly interact. In some embodiments, the interactive device may be connected to a separate computer system that provides the graphical representation for the consumer's selection and processes the input. In other embodiments, the interactive device and the computer that processes the input may be the same computer system.

The kiosk 902 may be a point of sale entry system used by a person other than the consumer. For example, the kiosk 902 may be an order entry system used by a clerk in the lobby of a walk-up store, such as a restaurant, hardware store, pharmacy, flower store, supermarket, deli, or other store. The clerk may be a relatively untrained person or may be highly skilled professional such as a physician or pharmacist, depending on the particular embodiment.

The standard order screen 904 may be a screen or series of navigable screens whereby an order taker, be it a clerk or consumer, may indicate items that they wish to order. In some embodiments, the same order screen 904 may be used over and over for a particular application, while in other embodiments, the order screen 904 may be changed substantially for each use. For example, in a fast food restaurant embodiment with a high degree of repeat customers, the screens 904 may be reused with little change. In other embodiments, the layout of the screens 904 may change with some frequency.

When one of the screens 904 is being prepared to be displayed, one or more of the items may be queried against an inventory system 908 by an inventory status function 906. The inventory system 908 may be capable of determining various inventory parameters about an item. The inventory system 908 may be able to provide a presence or absence indication showing that an item is available for purchase, the quantity of items available, the expiration date and time of each item available, configuration and location of the items, and other factors.

An item may be selected for promotion 910 based on several criteria. For example, a large quantity of a particular item may be present. Based on the quantity of the item, a determination may be made that the item may be discounted, enhanced, or otherwise promoted. In some cases, a calculation may be performed to determine the economic costs of keeping the item in inventory.

Some items may have an expiration time that may cause the item to be discarded at a certain time. In the determination of promotional items 910, the expiration time of the items may be compared to the current time to determine if an item should be promoted. In an embodiment of a fast food restaurant, there may be several hamburgers that are pre-made and waiting in inventory for sale. Each hamburger has a particular time that it was made and a corresponding time that it will be discarded if it is not purchased. The exemplary hamburger may be selected for promotion by evaluating the expiration time of the hamburgers in inventory.

Many calculations may be performed to determine if the expiration date of the inventory items should cause an item to be promoted by those skilled in the art while keeping within the spirit and intent of the present invention. For example, an economic analysis may include the cost of the item, the likelihood of purchase before the expiration time, the inventory carrying cost of the item, and other measurable economic indicators. In other examples, the inventory items may be compared to one or more predetermined values to determine if an item should be promoted.

In some embodiments, the expiration time of an inventory item may be in terms of minutes or even seconds, while other items may be in terms of hours, days, or even years. In an embodiment of a pre-made food restaurant, the items may expire in a matter of minutes and have a low cost of disposal. In an embodiment for the sale of pharmaceuticals, chemicals, live plants, cut flowers, food, or other items, the items may have a shelf life of many hours, days, or even years and may have a high cost of disposal.

When an item is determined to be promoted 910, the item may be enhanced 912. An item may be enhanced by providing visual and auditory changes to the interface at the kiosk 902 and by providing an economic discount or other incentive to purchase the specific item.

For example, a promotional item may be visually highlighted on a graphical interface on a consumer operated kiosk. In such an embodiment, a graphical representation of the item may be changed by changing the color of the graphical representation of the item, providing a special border around the item, animating the item, having special audio or other multimedia enhancements, or any other technique to draw the user's attention to the item.

In some embodiments, the position of the item on the screen may be changed to promote the item. In an embodiment where several selections may be displayed by a list, the item to be promoted may be moved higher in the list. In other embodiments, the item may be placed in a preferred position on the screen where it may be more easily recognized and selected.

On a kiosk operated by a store employee or someone other than the consumer, several methods may be used to promote the item. For example, a pop up screen or special text may be splashed on the display so that the employee may specifically suggest the item for sale.

In some cases, a special promotion may be made for a particular item. For example, an item may be offered for a discount or as a special offer in conjunction with another item.

In some embodiments, the process of finding inventory status 906, determining promotional items 910, and enhancing the promotional item 912 may occur before the initial standard order screen is presented or after some order entry 914 has occurred. In some embodiments prior to presenting an order screen, promotional items may be identified and highlighted.

In other embodiments, a standard screen may be presented and one or more items may be selected prior to offering a promotional item, and the selected items may be used to screen which items are offered for promotion. For example, if a consumer selects one particular item, such as a hamburger, that item may be evaluated for a promotional discount after selection. In such an example, all of the items are normally offered at full price, but discounted items may be offered after an initial selection. In another example, if the consumer orders a first hamburger, a second hamburger may be offered at a promotional discount. If the consumer ordered a salad, a hamburger may not be offered at a discount, even if a hamburger would otherwise be a promotional item.

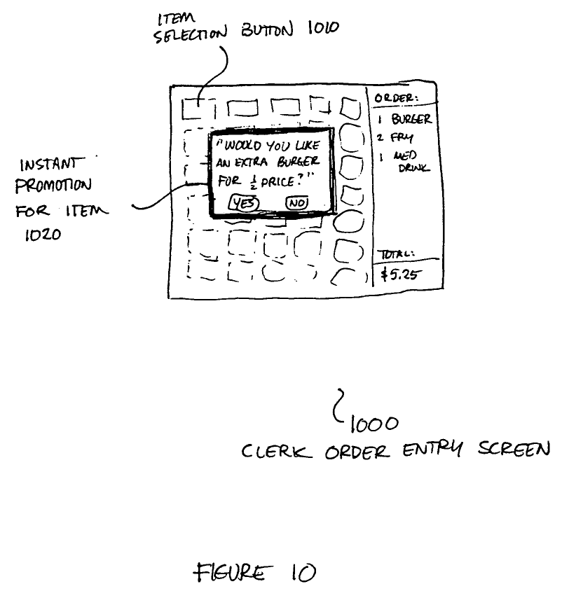

FIG. 10 is an illustration of a clerk order entry screen 1000. The screen may have many item selection buttons 1010 that are used by the clerk to place a customer's order. At some point during the order process, an item may be selected for promotion, in which case an instant promotion window 1020 may appear on the clerk's screen. The window 1020 may instruct the clerk to offer the consumer a promotional suggestion or discount for a particular item.

The embodiment 1000 may be used in customer operated kiosks, web page ordering screens, or other type of input terminals and is not limited to clerk order entry screens.

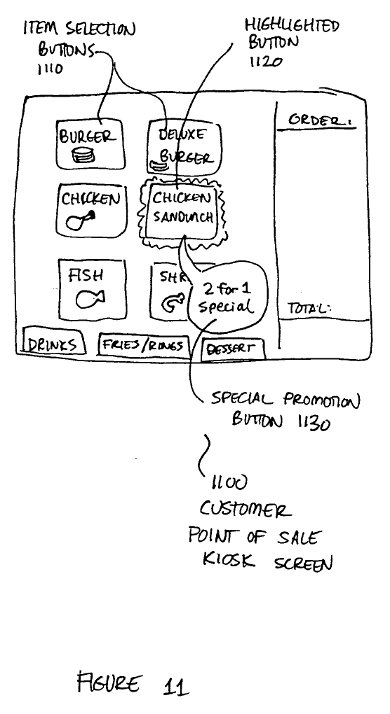

FIG. 11 is an illustration of a customer point of sale kiosk screen 1100. The screen 1100 may have several item selection buttons 1110 for individual items. Each button 1110 may be a hot spot on a touch screen interface. The highlighted button 1120 may have a special color, border, animation, or other eye-catching features to draw the user's attention to the item. Additionally, a special promotion button 1130 may be placed on the screen indicating the terms of the promotion.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method of assisting a customer at a point of sale location comprising:
determining a first group of items for a sales transaction by using a first computer system;
providing a graphical interface on a computerized point of sale terminal;
determining an expiration time of at least one item of said first group of items using said first computer system, said determining an expiration time comprising communicating with an inventory tracking system;
determining that said at least one item is suitable for promotion based at least in part on said expiration time;
creating a graphical representation of said first list of potential choices comprising enhancing said at least one item; and
displaying said graphical representation of said first list of potential choices on said graphical interface.

2. The method of claim 1 wherein said determination for promotion is performed by comparing said expiration time to a predetermined value.

3. The method of claim 2 wherein said predetermined value is based at least in part on the cost of discarding said at least one item.

4. The method of claim 1 wherein said enhancing comprises placing a graphical representation of said at least one item in a preferred position within said graphical representation.

5. The method of claim 1 wherein said enhancing comprises animating a graphical representation of said at least one item within said graphical representation.

6. The method of claim 1 wherein said enhancing comprises altering the color of at least a portion of a graphical representation of said at least one item within said graphical representation.

7. A system for assisting a customer at a point of sale terminal comprising:
a first computer system adapted to determine items for a sales transaction;
an inventory tracking system adapted of tracking at least one item of said items and providing an expiration time for said at least one item;
said first computer system further adapted to communicate with said inventory tracking system to determine an expiration time of at least one item of said items, determine that said at least one item is suitable for promotion based at least in part on said expiration time, and create a graphical representation of said items comprising enhancing said at least one item; and
a graphical interface on said point of sale terminal adapted to receive said graphical representation of said items and display said graphical representation.

8. The system of claim 7 wherein said first computer system is further adapted to determine that said at least one item is suitable for promotion by at least comparing said expiration time to a predetermined value.

9. The system of claim 8 wherein said predetermined value is based at least in part on the cost of discarding said at least one item.

10. The system of claim 7 wherein said first computer system is further adapted to enhance said at least one item by placing a graphical representation of said at least one item in a preferred position within said graphical representation.

11. The system of claim 7 wherein said first computer system is further adapted to enhance said at least one item by animating a graphical representation of said at least one item within said graphical representation.

12. The system of claim 7 wherein said first computer system is further adapted to enhance said at least one item by altering the color of at least a portion of a graphical representation of said at least one item within said graphical representation.

13. The system of claim 7 wherein said graphical interface comprises a second computer system.

14. The system of claim 7 wherein said first computer system comprises said graphical interface.

15. A system for assisting a customer at a point of sale location comprising:
a first means adapted to determine items for a sales transaction;
a second means for providing an expiration time for at least one item of said items;
said first means adapted to communicate with said second means and determine that said at least one item is suitable for promotion based at least in part on said expiration time, and create a graphical representation of said items comprising enhancing said at least one item; and
a third means for receiving and displaying said graphical representation of said items.

16. The system of claim 7 wherein said first means is further adapted to determine that said at least one item is suitable for promotion by at least comparing said expiration time to a predetermined value.

17. The system of claim 8 wherein said predetermined value is based at least in part on the cost of discarding said at least one item.

18. The system of claim 7 wherein said first means is further adapted to enhance said at least one item by placing a graphical representation of said at least one item in a preferred position within said graphical representation.

19. The system of claim 7 wherein said first means is further adapted to enhance said at least one item by animating a graphical representation of said at least one item within said graphical representation.

20. The system of claim 7 wherein said first means is further adapted to enhance said at least one item by altering the color of at least a portion of a graphical representation of said at least one item within said graphical representation.

21. The system of claim 7 wherein said first means comprises said third means.
